(19) United States
(12) Patent Application Publication
(10) Pub. No.: US 2015/0154916 A1
(43) Pub. Date: Jun. 4, 2015

(54) LIQUID CRYSTAL DISPLAY DEVICE AND BACKLIGHT DRIVING METHOD THEREOF

(71) Applicant: SHENZHEN CHINA STAR OPTOELECTRONICS TECHNOLOGY CO. LTD., Shenzhen, Guangdong (CN)

(72) Inventors: Xinhong Chen, Shenzhen (CN); Xiang Yang, Shenzhen (CN)

(21) Appl. No.: 14/240,382

(22) PCT Filed: Jan. 17, 2014
(86) PCT No.: PCT/CN2014/070845

§ 371 Date: Feb. 22, 2014

(30) Foreign Application Priority Data
Nov. 6, 2013 (CN) 201310549322.7

(51) Int. Cl. G09G 3/34; G09G 3/36

(52) U.S. Cl. CPC G09G 3/3406; G09G 3/36; G09G 2320/064; G09G 2320/0646; G09G 2320/0247

(57) ABSTRACT

The present invention provides a liquid crystal display device and a backlight driving method thereof. The liquid crystal display device includes a liquid crystal display panel and a backlight panel, wherein the liquid crystal display panel includes a main control unit, and the backlight panel includes light-emitting units and a backlight driving circuit. The backlight driving method comprises steps of: the main control unit outputting a frequency control signal; the backlight driving circuit outputting at least one diming control signal based on the frequency control signal sent by the main control unit, and periodically controlling turn-on and turn-off of the light-emitting units based on the dimming control signal; wherein frequency of the dimming control signal is N times of a screen refresh frequency of the liquid crystal display panel, and N is an integer greater or equal to 2. The method can effectively eliminate backlight flickers for liquid crystal display devices with an ultra-high degree of resolution. The present invention is especially suitable for LED backlight source liquid crystal display devices with an ultra-high degree of resolution.

### FIELD OF THE INVENTION

The present invention relates to a backlight driving technology for a display device, more particularly, to a liquid crystal display device that is able to eliminate backlight flickers under an ultra-high degree of resolution and a backlight driving method thereof.

### BACKGROUND OF THE INVENTION

It is well known that resolution is one of the key indexes to measure operation performances of an imaging device. The higher the resolution is, more dedicated the images displayed in an imaging device are. For a long time, resolution of 1080 pixels has been the major configuration for various display devices. However, with the development of technologies, the demand of customers also upgrades to a higher level. Nowadays, in order to, meet the requirements of market, not only liquid crystal display panels of small-size and portable electronic products are trending towards higher resolution, but also manufactures of, such as television and commercial display, are dedicated in developing display screens of higher-resolution.

There are multiple ways to improve resolution of liquid crystal display screen, one of which is to increase the number of display pixels by multiplying the number of scanning signal lines. For example, the number of scanning signal lines could be increased to 2160 from 1080 for a liquid crystal display panel with an ultra-high degree of resolution of 4K×2K. After scanning signal lines are multiplied, if a screen refresh frequency maintains 100 Hz or 120 Hz, then effective charge time for pixels would not be enough for liquid crystal molecules to response when one frame is scanned from top to bottom; if the screen refresh frequency is changed to 50 Hz or 60 Hz, according to the existing backlight driving principal for liquid crystal devices, backlight dimming shall be synchronized with screen refreshing, thereby the backlight dimming frequency shall also be changed to 50 Hz or 60 Hz.

At present, LED backlight driving technologies of liquid crystal display devices have almost been based on human vision suspend principle and used a periodical repeated pulse-modulated signal as a dimming control signal to control turn-on and turn-off of light-emitting units LED. Wherein, duty cycle of the pulse-modulated signal controls voltage amplitude loaded on the light-emitting units LED and thereby controls lightness degree of the light-emitting units LED, while the repetition frequency of the pulse-modulated signal is the backlight dimming frequency. With the action of periodical pulse-modulated signal, light-emitting units LED emit periodically pulse light to act on human retina. Theoretically, if the repetition frequency of pulse light is less than 20 Hz, human eyes may notice alternate shift between light-emitting state and lightless state of the light-emitting units LED, and thus may feel flickering of the screen. However, in a practical application, the frequency of pulse light needs to be greater than 100 Hz to guarantee human eyes from discomfort of flickering.

Therefore, how to eliminate backlight flickering under a lower backlight dimming frequency has become a technological problem to be solved urgently for a liquid crystal display panel with an ultra-high degree of resolution.

### SUMMARY OF THE INVENTION

With respect to above problem, the present invention provides a liquid crystal display device that is able to eliminate backlight flickers under an ultra-high degree of resolution, and a backlight driving method thereof.

The present invention provides a backlight driving method for a liquid crystal display device. Said liquid crystal display device includes a liquid crystal display panel and a backlight panel, wherein the liquid crystal display panel includes a main control unit, while the backlight panel includes light-emitting units and a backlight driving circuit. The backlight driving method comprises steps of: outputting, by the main control unit, a frequency control signal; and outputting, by the backlight driving circuit, at least one diming control signal based on the frequency control signal sent by the main control unit, and periodically controls turn-on and turn-off of the light-emitting units based on the dimming control signal; wherein frequency of the dimming control signal is N times of a screen refresh frequency of the liquid crystal display panel. N being an integer greater or equal to 2.

According to one embodiment of the backlight driving method in the present invention, the frequency control signal may be a switch control signal, and switch frequency of the switch control signal is N times of the screen refresh frequency of the liquid crystal display panel. N being an integer greater or equal to 2.

Further, the main control unit may also output a period control signal; and the backlight driving circuit adjusts action period of the dimming control signal based on the period control signal sent by the main control unit to control lightness of the light-emitting units.

Specifically, the dimming control signal may be a pulse-modulated signal.

Further, simultaneous with outputting two or more dimming control signals, the backlight driving circuit may also adjust phase of the dimming control signals, such that dimming control signals control light-emitting units to turn-on and turn-off in turns from top to down in terms of different time sequences.

According to one embodiment of the backlight driving method in the present invention, the main control unit may be MCU processor, while the backlight driving circuit may be a converter and the light-emitting units may be light-emitting diodes.

In addition, the present invention also provides a liquid crystal display device which includes:

a liquid crystal display panel, including a main control unit used to output a frequency control signal;

a backlight panel, including light-emitting units and a backlight driving circuit;

wherein the backlight driving circuit outputs at least one dimming control signal based on the frequency control signal output by the main control unit, and periodically controls the light-emitting units to turn on and turn off based on the dimming control signal; and

wherein frequency of the dimming control signal is N times of a screen refresh frequency of the liquid crystal display panel, N being an integer greater or equal to 2.

According to one embodiment of the liquid crystal display device in the present invention, the frequency control signal may be a switch control signal, and switch frequency of the switch control signal is N times of the screen refresh frequency of the LCD panel, N being an integer greater or equal to 2.

According to one embodiment of the liquid crystal display device in the present invention, the main control unit may be MCU processor, while the backlight driving circuit may be a converter and the light-emitting units may be light-emitting diodes.

Compared to the prior art, the advantages of the present invention are as follows. The backlight driving method proposed in the present invention is to perform frequency multiplication to the screen refresh signal S_{sync} of the liquid crystal display panel and use the multiplied frequency as a backlight dimming frequency of a backlight driving circuit. Specifically, a main control unit outputs a frequency control signal to the backlight driving circuit; the backlight driving circuit outputs at least one dimming control signal based on the frequency control signal, and periodically controls light-emitting units to turn on and turn off based on the dimming control signal; wherein frequency of the dimming control signal is N times of the screen refresh frequency of the liquid crystal display panel, and N is an integer greater or equal to 2. The backlight driving method proposed in the present invention is especially suitable for LED backlight source liquid crystal display devices with an ultra-high degree of resolution, and it can effectively eliminate backlight flickers for liquid crystal display devices with an ultra-high degree of resolution.

### BRIEF DESCRIPTION OF THE DRAWINGS

The drawings provide further understanding for the present invention, and constitute a part of the specification for interpreting the present invention together with the embodiments thereof, but not limit to the present invention, wherein:

FIG. 1 is a structure diagram of a liquid crystal display device using a backlight driving method of the present invention;

FIG. 2A is a measurement oscillogram of a backlight dimming frequency in a traditional PWM dimming technology for a liquid crystal display device;

FIG. 2B is a measurement oscillogram of backlight dimming frequency according to the backlight driving method of the present invention;

FIG. 3 is a diagram of local circuit in the backlight driving circuit on the LED backlight panel of a liquid crystal display device of the present invention.

### DETAILE DESCRIPTION OF THE INVENTION

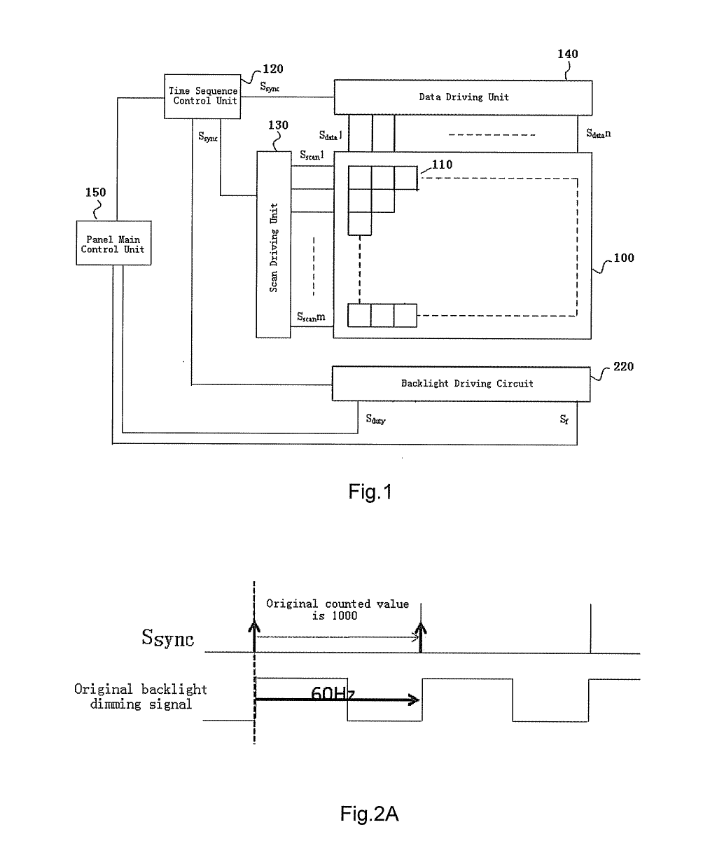

Referring to FIG. 1, it is a structure diagram of a liquid crystal display device using the backlight driving method of the present invention. The liquid crystal display device includes a liquid crystal display panel and a LED backlight panel. There are m×n pixel units 110 arranged on the array substrate 100 of the liquid crystal display panel. The LED backlight panel includes a plurality of sets of LED light-emitting unit 210, and each set of the light-emitting unit 210 corresponds to pixel units 110 of a certain number of rows. In addition, the liquid crystal display panel also comprises panel driving circuits, such as a time sequence control unit 120, a scan driving unit 130, a data driving unit 140 and a main control unit 150, e.g., MCU processer; the LED backlight panel also comprises a backlight driving circuit 220 electrically connected to the LED light-emitting units 210, Wherein: an input end of the time sequence control unit 120 is electrically connected to the main control unit 150 and a output end of the time sequence control unit 120 is electrically connected to the scanning driving unit 130, the data driving unit 140 and the backlight driving circuit 220 to receive control signals sent by the main control unit 150, and the sequence control unit 120 outputs screen refresh signals S_{sync} to the scanning driving unit 130, the data driving unit 140 and the backlight driving circuit 220 based on a control signal to synchronize operation of respective circuit units, thereby driving liquid crystal molecules to rotate and refresh the screen.

The scanning driving unit 130 receives a screen refresh signal S_{sync}, and output scanning signals S_{scan}1˜S_{scan}m in terms of time sequence to turn on switch elements of pixel units 110 in row 1 to row m from top to bottom.

The data driving unit 140 receives a screen refresh signal S_{sync} and writes data signals S_{data}1˜S_{data}n loading with picture information into corresponding pixel units 110 when the scanning driving unit 130 turns on a certain row of pixel units 110 from row 1˜row m.

The backlight drive circuit 220 is not only electrically connected to the time sequence control unit 120 to receive the screen refresh signal S_{sync}, but also electrically connected to the main control unit 150 to receive a period control signals S_{duty} and a frequency control signal S_{f} sent by the main control unit 150, and it accordingly output dimming control signals S_{dim1}˜S_{dim}n (not shown) based on the received period control signal S_{duty} and frequency control signal S_{f} to sequentially drive the LED light-emitting unit 210 periodically. In the case, the period control signal S_{duty} is used to control action period of the diming control signals S_{dim1}˜S_{dim}n, and the frequency control signal S_{f} is used to control output frequency of the dimming control signals S_{dim1}˜S_{dim}n, i.e., the backlight dimming frequency referred to in above description of background.

Referring to description of background, for a liquid crystal display panel with an ultra-high degree of resolution 4K×2K, if the backlight dimming frequency is same with the screen refresh frequency, which both are 50 Hz or 60 Hz, then the LED light-emitting units may flicker in the same frequency, which may cause discomfort of flickering to human eyes while watching the screen. To solve this problem, the present invention is able to perform frequency multiplication to the screen refresh signal of the liquid crystal display panel based on above driving circuit of the liquid crystal display to obtain a higher frequency index as the backlight dimming frequency of the backlight driving circuit. Specific implementation methodology is as following:

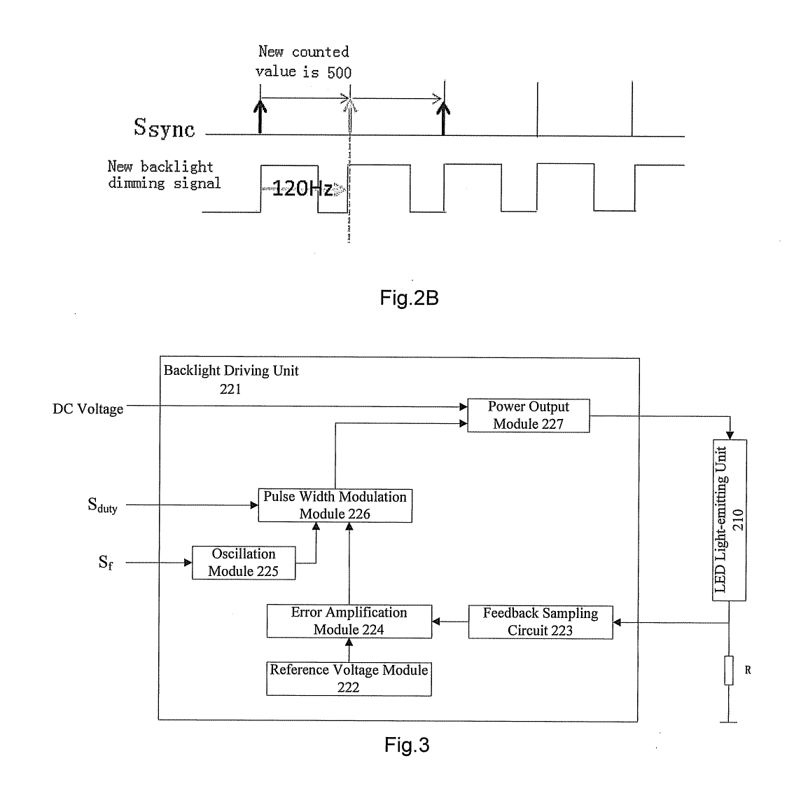

Referring to FIG. 2A, it is a measurement oscillogram of a backlight dimming frequency in a traditional PWM dimming technology for liquid crystal display devices. Generally, the main control unit 150 computes frequency F of current screen refresh signal S_{sync}; the main control unit 150 starts to count at the rising edge of the first screen refresh signal S_{sync} and stops counting at the rising edge of the second screen refresh signal S_{sync}, and thereby the frequency F of the current screen refresh signal S_{sync} exactly is a counting clock frequency divided by the counted value. For example, if the counting clock frequency is 60 KHz, and the value counted by the main control unit between the rising edge of the first screen refresh signal S_{sync} and the rising edge of the second screen refresh signal S_{sync} is 1000, then the frequency F of the current screen refresh signal S_{sync}is 60 Hz. Thereby, the backlight dimming frequency may be configured in terms of 60 Hz, such that backlight flickers may appear. Therefore, as shown in FIG. 2B, using the backlight driving method proposed in the present invention, after the main control unit 150 obtains the frequency F of the current screen refresh signal S_{sync}, the frequency F of the current screen refresh signal S_{sync} is divided by a predetermined multiplier N which is an integer equal to or greater than 2. In this way, a frequency index, such as 120 Hz, 180 Hz, 240 Hz etc., is obtained and used as the backlight dimming frequency of the backlight driving circuit 220. In another word, the frequency for controlling the backlight driving circuit to output the dimming control signals S_{dim}1˜S_{dim}n is an integer multiple of the screen refresh frequency. Generally speaking, as long as the frequency of the dimming control signals S_{dim}1˜S_{dim}n is greater than 100 Hz, backlight flickers can be eliminated.

Referring to FIG. 3, it is a schematic of local circuit in the backlight driving circuit on the LED backlight panel of a liquid crystal display device which is able to achieve technical effect referred to above. Generally, one backlight panel includes a plurality of sets of LED light-emitting unit 210 and each set of LED light-emitting unit 210 is independently drove by one backlight drive unit 221. Accordingly, one backlight driving circuit 220 also includes a plurality of backlight drive units 221. In the present embodiment, for convenience, FIG. 3 merely demonstrates connection of one set of LED light-emitting unit 210 and one backlight drive unit 221 thereof. As shown, the LED backlight panel adopts currently mainstream PWM pulse width modulation dimming technology to control the lightness and turn-on and off of the LED light-emitting unit 210, and it also has functions of automatic voltage and current stabilization.

Specifically, a backlight driving unit 221 comprises: a reference voltage module 222, which generates reference voltage and supplies internal power for other circuit modules; a feedback sampling circuit 223, which may collect a current signal flowing through the LED light-emitting unit 210 and transforms the current signal into a corresponding voltage signal by a sampling resistor R, and then outputs the voltage signal as a feedback sampling voltage; a error amplification module 224, which receives the reference voltage supplied by the reference voltage module 222 and the feedback sampling voltage supplied by the feedback sampling circuit 223, and amplifies a voltage difference therebetween and then outputs the voltage difference; an oscillation module 225, which receives the frequency control signal S_{f} from the main control unit 150 and outputs an oscillation signal of a certain frequency under the action of the frequency control signal S_{f}; a pulse width modulation module 226, which receives the period control signal S_{duty} from the main control unit 150, the voltage difference amplified signal from the error amplification module 224 and the oscillation signal from the oscillation module 225, and accordingly outputs a periodical pulse-modulated signal having a certain duty cycle as the dimming control signal based on these signals. The action period of the pulse-modulated signal, i.e., the duty cycle thereof, is determined by the period control signal S_{duty} together with the voltage difference amplified signal. The output frequency of the pulse-modulated signal is determined by frequency of the oscillation signal, that is, it is indirectly determined by the frequency control signal S_{f}; and a power output module 227, which receives the periodical pulse-modulated signal from the pulse width modulation module 226, that is, the dimming control signal, and controls turn-on and turn-off of a power switch diode at the output end (not shown) based on the periodical pulse-modulated signal. When the switch diode is in turn-off, the DC voltage used for operation of the LED light-emitting unit 210 is loaded on anode side of the LED light-emitted unit 210, and the LED light-emitting unit 210 luminesces; When the switch diode is in turn-on, the anode side of the LED light-emitted unit 210 is shorted to ground, and the LED light-emitting unit 210 is turned off and in non-luminance.

In the embodiment above, the frequency control signal S_{f} output to the backlight driving unit from the main control unit 150 may be a on/off switch control signal. As long as its switch frequency is set as N times of the frequency of the screen refresh signal S_{sync} of the liquid crystal display panel and N is an integer equal to or greater than 2, the backlight driving unit may output a pulse-modulated signal, the frequency thereof is N times of the frequency of the screen refresh signal S_{sync}, to control turn-on and turn-off of the LED light-emitting unit 210, such that backlight flickering phenomenon is eliminated.

In the embodiment above, although it is only demonstrated the case that one backlight driving unit drives one set of LED light-emitting unit to work, it is excluded the cases that above backlight driving method can be applied for a plurality of sets of LED light-emitting unit operating in a simultaneous or alternate manner. When number of the LED light-emitting units 210 on the LED backlight panel of a liquid display device is large, for example, in the case that four sets of LED light-emitting unit 210 are included and respectively driven by four backlight drive units 221, a set of control signals can be used to control the pulse-modulated signals output by the four backlight drive units 221 to successively shift phase of 90 degree, such that the four sets of LED light-emitting unit 210 are controlled to turn on or off from top to bottom in turn. In this way, lightness of the LED backlight panel operating in this manner is uniform with minimum interference. Moreover, since the frequency of the pulse-modulated signals output by the four backlight driving units 221 is N times of the frequency of the screen refresh signals Ssync in a liquid crystal display panel, and N is an integer greater or equal to 2, problem of backlight flickering may be eliminated completely. Since phase-shift is an existing technology and not the emphasis of the present invention, it is not discussed in detail herein.

In the embodiments above, although the LED backlight technology is used in the liquid crystal display device, it is obvious that the present invention is not limited thereto but can also be used to drive other light sources. Only the preferred embodiments are specified above, but the protection scope of the present invention is not limited to so. Modifications or alternatives that can be readily conceivable for anyone familiar with this art should also be covered by present invention. Therefore the protection scope of the present invention should be subjected to the scope of appended claims.

What is claimed is:

1. A backlight driving method for a liquid crystal display device, the liquid crystal display device including a liquid crystal display panel and a backlight panel, wherein the liquid crystal display panel includes a main control unit, and the backlight panel includes light-emitting units and a backlight driving circuit,
the backlight driving method comprising steps of:
outputting, by the main control unit, a frequency control signal; and
outputting, by the backlight driving circuit, at least one diming control signal based on the frequency control signal sent by the main control unit, and periodically controlling turn-on and turn-off of the light-emitting units based on the dimming control signal;
wherein frequency of the dimming control signal is N times of a screen refresh frequency of the liquid crystal display panel, N being an integer greater or equal to 2.

2. The backlight driving method according to claim 1, wherein,
the frequency control signal is a switch control signal, and switch frequency of the switch control signal is N times of the screen refresh frequency of the liquid crystal display panel, N being an integer greater or equal to 2.

3. The backlight driving method according to claim 1, wherein,
the main control unit further outputs a period control signal; and
the backlight driving circuit adjusts action period of the dimming control signal based on the period control signal sent by the main control unit to control lightness of the light-emitting units.

4. The backlight driving method according to claim 2, wherein,
the main control unit further outputs a period control signal; and
the backlight driving circuit adjusts action period of the dimming control signal based on the period control signal sent by the main control unit to control lightness of the light-emitting units.

5. The backlight driving method according to claim 3, wherein the dimming control signal is a pulse-modulated signal.

6. The backlight driving method according to claim 4, wherein the dimming control signal is a pulse-modulated signal.

7. The backlight driving method according to claim 1, wherein simultaneous with outputting two or more dimming control signals, the backlight driving circuit further adjusts phase of the dimming control signals, such that dimming control signals control light-emitting units to turn-on and turn-off in turns from top to down in terms of different time sequences.

8. The backlight driving method according to claim 2, wherein simultaneous with outputting two or more dimming control signals, the backlight driving circuit further adjusts phase of the dimming control signals, such that dimming control signals control light-emitting units to turn-on and turn-off in turns from top to down in terms of different time sequences.

9. The backlight driving method according to claim 1, wherein the main control unit uses MCU processor, the backlight driving circuit is a converter and the light-emitting units are light-emitting diodes.

10. The backlight driving method according to claim 2, wherein the main control unit uses MCU processor, while the backlight driving circuit is a converter and the light-emitting units are light-emitting diodes.

11. A liquid crystal display device, comprising:
a liquid crystal display panel including a main control unit used to output a frequency control signal;
a backlight panel including light-emitting units and a backlight driving circuit;
wherein the backlight driving circuit outputs at least one dimming control signal based on the frequency control signal output by the main control unit, and periodically controls the light-emitting units to turn on and turn off based on the dimming control signal; and
wherein frequency of the dimming control signal is N times of a screen refresh frequency of the liquid crystal display panel, N being an integer greater or equal to 2.

12. The liquid crystal display device according to claim 11, wherein the frequency control signal is a switch control signal, and switch frequency of the switch control signal is N times of the screen refresh frequency of the liquid crystal display panel, N being an integer greater or equal to 2.

13. The liquid crystal display device according to claim 11, wherein,
the main control unit further outputs a period control signal; and
the backlight driving circuit adjusts action period of the dimming control signal based on the period control signal sent by the main control unit to control lightness of the light-emitting units.

14. The liquid crystal display device according to claim 12, wherein
the main control unit further outputs a period control signal; and
the backlight driving circuit adjusts action period of the dimming control signal based on the period control signal sent by the main control unit to control lightness of the light-emitting units.

15. The liquid crystal display device according to claim 11, wherein simultaneous with outputting two or more dimming control signals, the backlight driving circuit further adjusts phase of the dimming control signals, such that dimming control signals control light-emitting units to turn-on and turn-off in turns from top to down in terms of different time sequences.

16. The liquid crystal display device according to claim 12, wherein simultaneous with outputting two or more dimming control signals, the backlight driving circuit further adjusts phase of the dimming control signals, such that dimming control signals control light-emitting units to turn-on and turn-off in turns from top to down in terms of different time sequences.

17. The liquid crystal display device according to claim 13, wherein simultaneous with outputting two or more dimming control signals, the backlight driving circuit further adjusts phase of the dimming control signals, such that dimming control signals control light-emitting units to turn-on and turn-off in turns from top to down in terms of different time sequences.

18. The liquid crystal display device according to claim 14, wherein simultaneous with outputting two or more dimming control signals, the backlight driving circuit further adjusts phase of the dimming control signals, such that dimming control signals control light-emitting units to turn-on and turn-off in turns from top to down in terms of different time sequences.

19. The liquid crystal display device according to claim 11, wherein the main control unit uses MCU processor, while the backlight driving circuit is a converter and the light-emitting units are light-emitting diodes.

20. The liquid crystal display device according to claim 12, wherein the main control unit uses MCU processor, while the backlight driving circuit is a converter and the light-emitting units are light-emitting diodes.
